(19) United States
(12) Patent Application Publication
(10) Pub. No.: US 2026/0321080 A1
(43) Pub. Date: Oct. 15, 2026

(54) ELECTRONIC VEHICLE KEY HAVING INTERCHANGEABLE END CAP

(71) Applicant: Re:Car Inc., Troy, MI (US)

(72) Inventors: Tomoyuki Ishiwata, Fountain Valley, CA (US); Andrew Sulkowski, Howell, MI (US); David Stuttard, De Pere, WI (US)

(21) Appl. No.: 19/642,790

(22) Filed: Apr. 9, 2026

Related U.S. Application Data
(60) Provisional application No. 63/786,900, filed on Apr. 10, 2025.

(51) Int. Cl. G07C 9/00

(52) U.S. Cl. CPC G07C 9/00944

(57) ABSTRACT

An electronic vehicle key for a vehicle that includes: a main body having an enclosed interior space defined between a top side and an opposing bottom side, a first end having a first end wall, and an opposing second end having a second end wall, the enclosed interior space containing one or more electrical components configured to enable the electronic vehicle key to communicate with the vehicle and/or to operate one or more vehicle features; one or more buttons at the top side of the main body; a first attachment feature located at the second end of the main body; and an end cap having a second attachment feature configured to removably engage the first attachment feature; upon removal of the end cap from the main body, access to the enclosed interior space remains blocked by the second end wall.

### CROSS-REFERENCE TO RELATED APPLICATIONS

This application claims the benefit of US 63/786,900 dated Apr. 10, 2025, the entirety of which is hereby incorporated by reference herein for all purposes.

### FIELD

These teachings relate to a key for a vehicle, and more particularly to a vehicle key having an interchangeable end cap.

### BACKGROUND

Some vehicles make use of electronic keys that allow a vehicle operator to control one or more vehicle features, such as locking or unlocking the vehicle and/or starting the vehicle.

Sleeves or covers, such as those disclosed in US 2008/0142129 A1, allow a user to customize the appearance of a key fob. However, in vehicles that require insertion of the key fob into a vehicle key receptacle or slot to start and/or operate the vehicle, such sleeves or covers may increase one or more dimensions of the key fob and interfere with or prevent insertion into the vehicle key receptacle or slot.

Some electronic keys are configured to be inserted into a vehicle key receptacle or slot in a specific orientation. Ensuring proper orientation of the electronic key in the receptacle may be inconvenient for a vehicle operator, particularly in time-sensitive or emergency situations.

It may therefore be desirable to have an electronic key that can be customized by a user, and still be capable of inserting into a vehicle key receptacle or slot. It may be desirable to have an electronic key that can be inserted into a vehicle key receptacle in at least two different orientations.

### SUMMARY

The present teachings relate to a vehicle key, such as an electronic key, key fob, or combination thereof, that is configured to operate one or more vehicle features. The vehicle key is configured to be received within a vehicle key receptacle or slot while also permitting a user to customize the vehicle key.

The electronic key according to these teachings comprises a body and an end cap. The end cap is configured to be removable or separable from the body. The end cap can be removed or separated from the body so that, optionally, another endcap can be attached to the body. Advantageously, the key according to these teachings allows a user to interchange a variety of end caps onto the body of the key, so that a user can customize the key according to their preference.

The electronic vehicle key according to these teachings includes structure that enables a quick and easy swapping or replacement of the end cap without having to take apart and potentially damage the electronic key. The end cap can be swapped or replaced with another end cap without the need for tools. Upon removing or separating one end cap from the body, the interior space of the electronic key remains closed or enclosed so that the circuitry for operating one or more features of the electronic key and/or vehicle is not exposed, which may reduce damage to the circuitry if water, debris or the like enters the interior space for example.

Th electronic key according to these teachings is also configured to be inserted into a vehicle key receptacle or slot in the vehicle. Advantageously, the electronic key can be inserted into the vehicle key receptacle or slot with the buttons of the electronic key facing up, or with the buttons of the electronic key facing down. The vehicle and or the vehicle dashboard are configured to accommodate a vehicle key fob that is inserted into the key receptacle in any direction or orientation and still allow for the key to function and operate the vehicle in its intended manner. Advantageously, this allows a user to insert the electronic key according to these teachings into the vehicle key receptacle or slot without having to worry about whether the key is positioned in the proper orientation. This may be useful in an emergency situation, such as when there is poor lighting inside the vehicle, and/or if the vehicle operator is in a hurry.

The electronic vehicle key has a main body that houses internal electronic components within an enclosed interior space and includes user-accessible buttons on an exterior surface. The main body further includes a first attachment feature at one end that cooperates with a removable end cap having a complementary second attachment feature. The end cap is releasably secured to the main body via a mechanical engagement (e.g., snap-fit, interference fit, or friction fit) that includes one or more resilient, cantilevered fingers that engage an opening in a surrounding wall of the main body. Notably, removal of the end cap does not expose or provide access to the enclosed interior space, which remains sealed by opposing end walls of the main body. The main body is further configured for insertion into a vehicle key receptacle and includes engagement surfaces or features that cooperate with retaining arms or detents within the receptacle to secure the key in place. The configuration permits insertion in multiple orientations while maintaining secure retention, and the end cap is sized and arranged such that it does not interfere with insertion into the receptacle, with at least a portion optionally remaining external to the receptacle when installed.

### BRIEF DESCRIPTION OF THE DRAWINGS

FIG. 1 is perspective view of a vehicle dashboard.

FIG. 2A is a top perspective view of an electronic vehicle key.

FIG. 2B is a bottom perspective view of an electronic vehicle key.

FIG. 3A is a partially exploded top perspective view of an electronic vehicle key.

FIG. 3B is a partially exploded bottom perspective view of an electronic vehicle key.

FIG. 4 is a partial perspective view of an electronic vehicle key.

FIG. 5 is an exploded perspective view of an electronic vehicle key.

FIGS. 6A-6I illustrate various end caps.

FIG. 7 is a cross sectional view of an electronic vehicle key inserted into or received in a vehicle key receptacle of a vehicle.

FIG. 8 illustrates a vehicle in a first or pickup truck configuration.

FIG. 9 illustrates a vehicle in a second or SUV configuration.

### DETAILED DESCRIPTION

The electronic vehicle key may be a key, a key fob, or other controller or device that may enable a user to gain access into a vehicle, control one or more features of the vehicle, or a combination thereof. For example, the electronic vehicle may be a key fob or hand-held remote control device designed to operate vehicle functions including starting and stopping the vehicle, door locking/unlocking, front frunk operation, HV battery preconditioning, horn operation, and emergency panic alarm activation, or a combination thereof.

The electronic key may have electronic circuitry that enables communication between the electronic key and a controller, computer, or other device of the vehicle or feature of the vehicle. The device may be powered by a replaceable battery and utilize RF communication to interface with the vehicle. The battery may be rechargeable. The battery may be charged when inserted in the vehicle key receptacle in the vehicle or dashboard.

The communication between the electronic key or electronic circuitry thereof and the vehicle or the vehicle feature may be a near field communication protocol such as RFID, radio frequency (RF) technology, Bluetooth, cellular, radio waves, Wi-Fi, the like, or a combination thereof. The electronic key may operate within the UHF band frequencies of 433 MHz (425 MHz to 480 MHz) in compliance with ETSI EN 300220 and within the LF band frequency of 125 kHz (100 kHz to 150 kHz). The electronic key may meet Electromagnetic Interference (EMI) and Electromagnetic Compatibility (EMC) requirements as per ISO 11452 and SAE J1113 standards. The RF signaling system for the electronic key shall operate at 433.92 MHz. The RF signaling system for the electronic key shall transmit with a strength of 10 dB. The RF signaling system for the electronic key shall have 30 ppm accuracy at 25C assuming an oscillator having frequency 24.305 H.z. The electronic key may support a data rate of up to 7.8 Kbps for LF communication at 125 kHz and a data rate of up to 80 Kbps for UHF communication at 433 MHz. The data rate and communication protocol shall be fully compatible with the vehicle’s Remote Keyless Entry (RKE) system as specified in SAE J2534 standards.

The electronic vehicle key according to these teachings comprises at least two parts (e.g., or two or more parts). The parts may be a main part or body and an end cap. The two parts are intended, configured, or adapted to be separable. This separability may allow a user the freedom or ability to attach a different end cap to the main body from the one that originally came with the main body. The electronic key may operate with or without an end cap. In other words, the electronic key can still operate the vehicle and/or control various vehicle components even if the end cap is not attached to the body. This is possible at least in part because the circuity associated with the vehicle key is within the main body part and is not affected if the end cap is separated from the main body part. In some other configurations, the electronic vehicle key may not function or operate without the end cap being attached thereto. That is, the key may include a sensor or other device that may sense presence or absence of an end cap and allow or prevent the electronic key from properly functioning.

The interface between the main body part and the end cap may comprise one or more attachment features. An attachment features may be structure that allows or enables the main body and the end cap to remain attached. The attachment features may be structure that enables or allows the main body and the end cap to be separated. An attachment features may be structure that allows or enables a different end cap than the one that originally came with the body to be attached to the body, without permanently destroying or damaging the main body and/or end cap. In other words, the structure may allow for the main body and end cap to be separated, attached, separated, attached etc. any number of times without permanently damaging or destroying the structure of the attachment device, main body, end cap, etc.

The attachment features may include a seal or gasket that prevents water or contaminants from entering the region between the end cap and the main body (e.g., into the pocket and/or the interior region of the main body that includes the circuity and battery). The seal or gasket may be a rubber or other soft plastic material.

While the teachings herein discuss the first attachment features being on the main body part and the second attachment features being on the end cap, it is within the scope of these teachings that the first attachment features is on the end cap and the second attachment features is on the main body. In other words, the pocket may be on the end cap and the male part or fingers may be on the main body part.

The electronic key, the main body, and/or the end cap may be made of a plastic material, such as polypropylene, nylon, ABS plastic (UL 94V0 rated for flammability), etc. The material may be filled with glass, talc, or other additives. The material may be free of any glass, talc, or other additives. The end cap and/or main body may be colored, painted, or covered with a film or wrap. In other configurations, the end cap and/or main body may have a black, white, clear, transparent, or translucent appearance. The main body, the end cap, or both may be made from a suitable process such as molding, injection molding, 3D printing, casting, or a combination thereof. The end cap may be customizable. The end cap may be designed and printed by a user.

Reference is made to the following illustrations which further illustrate and describe the vehicle key and its components.

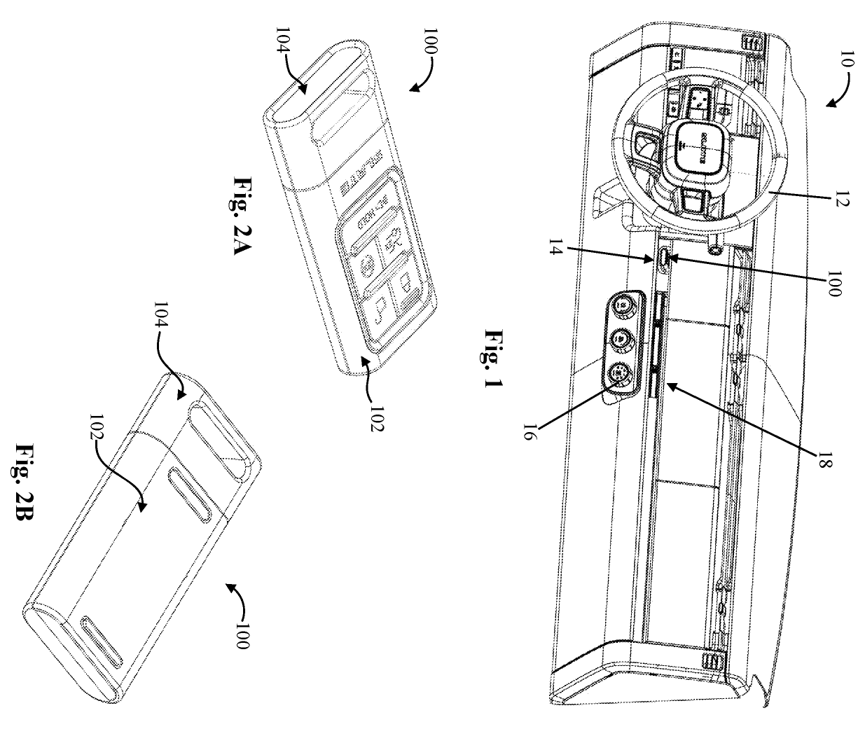

FIG. 1 illustrates a vehicle dashboard 10. The dashboard 10 generally comprises a steering wheel 12, a vehicle key receptacle 14 configured to receive an electronic vehicle key 100, HVAC or other vehicle controls 16, and an accessory rail 18 configured to support or mount one or more accessories, such as a mobile device holder or speaker, at the dashboard 10.

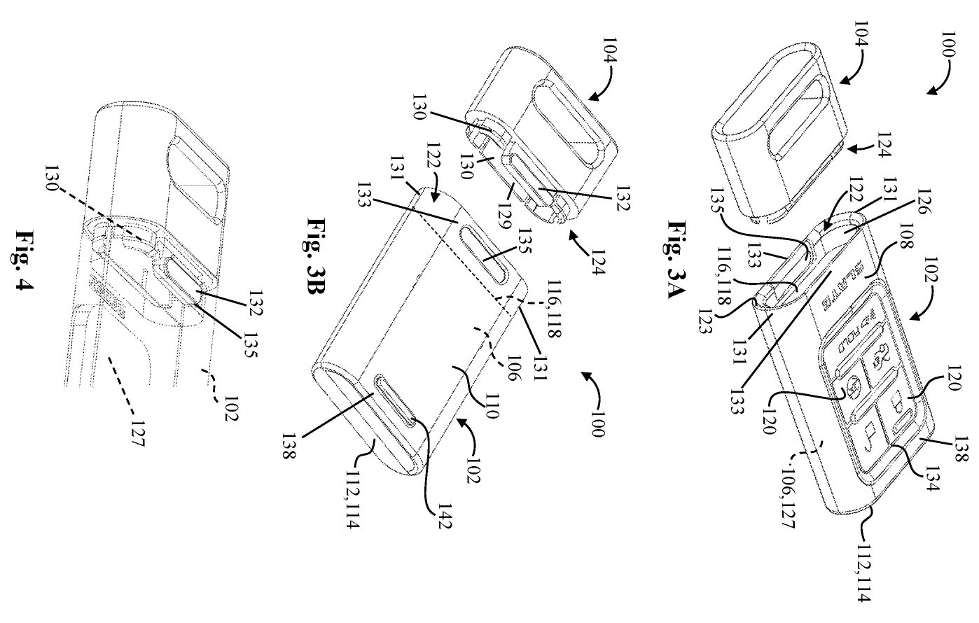

FIGS. 2A and 2B illustrate an electronic vehicle key 100. The electronic vehicle key 100 comprises a main body 102 and an end cap 104. The end cap 104 is configured to be removably connected to the main body 102. The electronic vehicle key 100 is shown in a connected or assembled configuration in which the end cap 104 is connected, attached, or otherwise engaged with the main body 102.

As used herein, “removably connected” may refer to a connection between the main body 102 and the end cap 104 in which the end cap 104 can be separated from the main body 102, without permanently damaging or destroying the end cap 104 and/or the main body 102. The end cap 104 and the main body 102 may be separated from one another by a user, for example, using their fingers or optionally with a simple tool. The function and/or operation of the electronic vehicle key 100 is not affected if the end cap 104 is or is not attached to the main body 102 of the electronic key 100. In other words, the vehicle key 100 can still be used to operate and/or control the vehicle and/or one or more of the vehicle components if the end cap 104 is connected or disconnected from the main body 102.

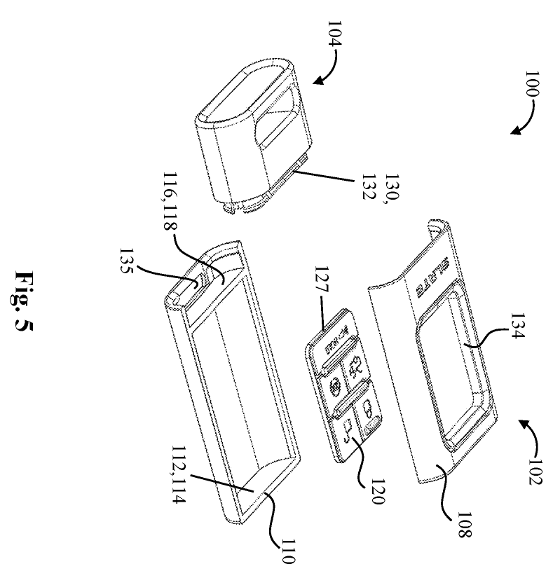

Referring now to FIGS. 3A and 3B, the electronic vehicle key 100 is illustrated in a disassembled or separated configuration. In FIG. 4 the electronic vehicle key 100 is illustrated in an assembled or connected configuration.

The electronic vehicle key 100 comprises a main body 102 and an end cap 104.

The main body 102 comprises one or more enclosed interior spaces 106. The enclosed interior space(s) 106 may contain one or more electrical components 127 of the electronic vehicle key 100, such as circuitry, microcontrollers, batteries, controllers, antennas, communication devices, or other electronic components configured to enable the electronic vehicle key 100 to communicate with the vehicle and/or to operate one or more features of the vehicle.

The main body 102, including the enclosed interior space 106, is defined by a top side 108 and an opposing bottom side 110, a first end wall 114 located at a first end 112 of the main body 102, and an opposing second end wall 118 located at a second end 116 of the main body 102.

The top side 108 of the main body 102 comprises a keypad or one or more buttons 120 for operating the vehicle or one or more features of the vehicle. The top side 108 may comprise an aperture or opening 134 through which the keypad and/or buttons 120 extend or are accessible.

The main body 102 may comprise an attachment feature 122, and the end cap 104 may comprise an attachment feature 124 configured to engage the attachment feature 122 on the main body 102 to enable attachment and separation of the end cap 104 relative to the main body 102.

The attachment feature 122 on the main body 102 may be referred to herein as a first attachment feature 122, and the attachment feature 124 on the end cap 104 may be referred to herein as a second attachment feature 124, to distinguish between the respective attachment features.

The first attachment feature 122 may be located at the second end 116 of the main body 102.

The first attachment feature 122 may comprise a sleeve, receptacle, or pocket 126. The sleeve, receptacle, or pocket 126 may include a wall 128 circumferentially extending from the second end wall 118. The wall 128 may be configured as a circumscribing wall or surrounding wall or cantilever wall that extends from and/or around at least a portion of the second end wall 118 and projects distally beyond the second end wall 118. In this manner, the second end wall 118 may be recessed relative to a distal-most end 123 or free end 123 of the main body 102 or the wall 128.

The circumscribing wall 128 may comprise a pair of long wall portions or segments 133 and a pair of short wall portions or segments 131. The short wall portions or segments 131 may be shorter in length than the long wall portions or segments 133. The short wall portions or segments 131 may be arranged generally perpendicular or orthogonal to the long wall portions or segments 133.

The first attachment feature 122, including the sleeve, receptacle, or pocket 126, may further comprise one or more engagement windows or openings 135. The one or more engagement windows or openings 135 may be defined in at least a portion of the surrounding wall 128.

In one example, an engagement window or opening 135 may be defined in a long wall portion or segment 133 of the surrounding wall 128, for example, at or adjacent to the bottom side 110 of the main body 102.

In some embodiments, one or more engagement windows or openings 135 may be defined in one or more of the long wall portions 133 of the surrounding wall 128 and/or one or more of the short wall portions 131 of the surrounding wall 128. Additionally, or alternatively, one or more engagement windows or openings 135 may be positioned at or adjacent to the top side 108 of the main body 102.

The second attachment feature 124 of the end cap 104 may comprise a male part 129. The male part 129 may be sized to be received within the receptacle or pocket 126 (e.g., within the surrounding wall 128). In some configurations, the male part 129 may define a distal-most end of the end cap 104.

The male part 129 may comprise one or more fingers 130. The one or more fingers 130 may cantilever from the distal-most end of the end cap 104. Ends of one or more of the fingers 130 may include one or more protuberances 132.

The second attachment feature 124 may comprise one or more fingers 130 and/or one or more protuberances 132 configured to engage the first attachment feature 122. For example, the one or more fingers 130 and/or protuberances may engage one or more features, walls, undercuts, tabs, or other structure of the first attachment device in a friction or interference fit. The one or more fingers or protuberances may extend at least partially into or through the one or more engagement windows or openings 135, as illustrated in FIG. 4, to engage or lock the end cap 104 to the main body 102.

In some configurations, a tactile feedback may be provided to a user upon attachment of the end cap 104 to the main body 102. Such feedback may occur, for example, when the one or more fingers 130 and/or protuberances 132 snap into the one or more engagement windows or openings 135.

The engagement between the end cap 104 and the main body 102 may be sufficient to exhibit little or no Buzz, Squeak, and Rattle (BSR) under vibration, shock, and handling conditions, for example, as evaluated in accordance with SAE J575 and ISO 16750-3.

To separate the end cap 104 from the main body 102, a force or pressure may be applied to the protuberance 132 and/or finger 130 through the window or opening 135 to bias the protuberance 132 and/or finger 130 inwardly and out of the window or opening 135. This disengages the second attachment feature 124 from the first attachment feature 122 and enables separation of the end cap 104 from the main body 102.

The force or pressure may be applied by a user’s finger or with a tool. In some configurations, the window or opening 135 may be located on a side of the main body 102 that is opposite the top side 108 comprising the one or more buttons 120.

In some configurations, the end cap 104 and the main body 102 may be pulled in opposite directions with a sufficient force to overcome any retaining forces generated by the first nad second attachment features 122, 124. In other words, the force may be sufficient to cause the one or more fingers to bias or flex out of engagement with the one or more openings or other features of complementary attachment device.

As shown in FIG. 3A, after the end cap 104 is separated from the main body 102, access to the enclosed interior space 106 remains blocked by the second end wall 118. In other words, upon removal or separation of the end cap 104 from the main body 102, the interior space 106 of the electronic key 100 remains closed within the main body 102.

Advantageously, the circuitry 127 in the interior space 106 for operating one or more features of the electronic key 100 and/or the vehicle remains unexposed, which may reduce the likelihood of damage to the electronic key 100. This configuration may also help protect the interior space 106 from environmental contaminants, such as dust, dirt, and water spray, including in situations involving temporary exposure to water.

The interior space, defined by the top and bottom surfaces of the main body and the opposing end walls, may be fluid tight to prevent fluid nad/or debris from entering the interior space.

In some configurations, the interior space 106 may be accessed by using a tool or by manipulating a separate attachment feature to permit access, for example, to replace a battery.

The orientation of the end cap 104 and the second attachment feature 124 may be configured such that the end cap 104 can engage the main body 102 in either a first orientation or a second orientation rotated approximately 180 degrees relative to the first orientation. This may allow a user to attach the end cap 104 to the main body 102 without requiring a specific orientation.

In other configurations, the end cap 104 can only engage the main body 102 in a specific single orientation, based on the layout or orientation of the complementary features of the first and second attachment devices (e.g., location or orientation of the openings and corresponding fingers).

FIG. 5 illustrates the electronic vehicle key 100. The main body 102 comprises an enclosed interior space 106 defined by the top side 108 and the opposing bottom side 110. The top side 108 and the bottom side 110 may together define a clamshell structure comprising two discrete pieces joined together by one or more fasteners, such as screws, adhesive, plastic welding, clips, or a combination thereof.

The first end wall 114 and the opposing second end wall 118 may be part of, or integrally formed with, the bottom side 110 of the main body 102. The enclosed interior space 106 may house or contain one or more components 127, such as circuitry, batteries, controllers, antennas, or other electronic components configured to communicate with the vehicle and operate one or more vehicle features.

The top side 108 may comprise a window 134 through which the one or more buttons 120 are accessible for operating the vehicle and/or the electronic vehicle key 100. The window 134 may be configured to allow actuation of the buttons 120 while maintaining enclosure of the interior space 106.

In some configurations, the second attachment feature 124 of the end cap 104 is configured to be inserted into the first attachment feature 122 of the main body 102 along an insertion direction, such as an axial direction relative to the sleeve, receptacle, or pocket 126. During insertion, the wall 128 of the first attachment feature 122 may guide alignment of the second attachment feature 124 relative to the main body 102. Continued insertion may cause portions of the second attachment feature 124, such as one or more fingers 130 and/or protuberances 132, to contact the surrounding wall 128 and/or edges of the engagement openings 135.

In some configurations, the one or more fingers 130 and/or protuberances 132 may be bias able and/or elastically deformable, to facilitate engagement and disengagement between the second attachment feature 124 and the first attachment feature 122. For example, upon insertion of the second attachment feature 124 into the sleeve 126, the one or more fingers 130 may deflect inwardly as the protuberances 132 contact the surrounding wall 128. Upon further insertion, the one or more fingers 130 may return toward an unbiased state such that the protuberances 132 extend into or through the engagement openings 135 to retain the end cap 104 on the main body 102.

In some configurations, the engagement between the second attachment feature 124 and the first attachment feature 122 may be achieved through an interference fit, friction fit, snap-fit engagement, or a combination thereof. The biasable nature of the one or more fingers 130 and/or protuberances 132 may contribute to a retention force between the end cap 104 and the main body 102 sufficient to maintain attachment during normal use, while still permitting removal when a sufficient disengagement force is applied.

To disengage the end cap 104 from the main body 102, a force may be applied to the protuberances 132 and/or fingers 130, for example, through the engagement openings 135, to bias the one or more fingers 130 inwardly and out of engagement with the openings 135. Once disengaged, the second attachment feature 124 may be withdrawn from the first attachment feature 122 along a direction opposite the insertion direction. In some configurations, this disengagement may be performed manually by a user or with the assistance of a tool.

In some configurations, attachment and removal of the end cap 104 occurs without disassembly of the main body 102. The enclosed interior space 106 remains defined by the top side 108, bottom side 110, and end walls 114, 118 regardless of whether the end cap 104 is attached or removed. As a result, the circuitry within the interior space 106 remains enclosed and protected during attachment, removal, and replacement of the end cap 104.

In some configurations, the electronic vehicle key 100, including the end cap 104 when attached, is configured to fit within dimensional constraints of a vehicle key receptacle 14. The end cap 104 may be configured such that attachment of the end cap 104 does not substantially increase one or more dimensions of the main body 102 in a manner that would interfere with insertion of the electronic vehicle key 100 into the vehicle key receptacle 14.

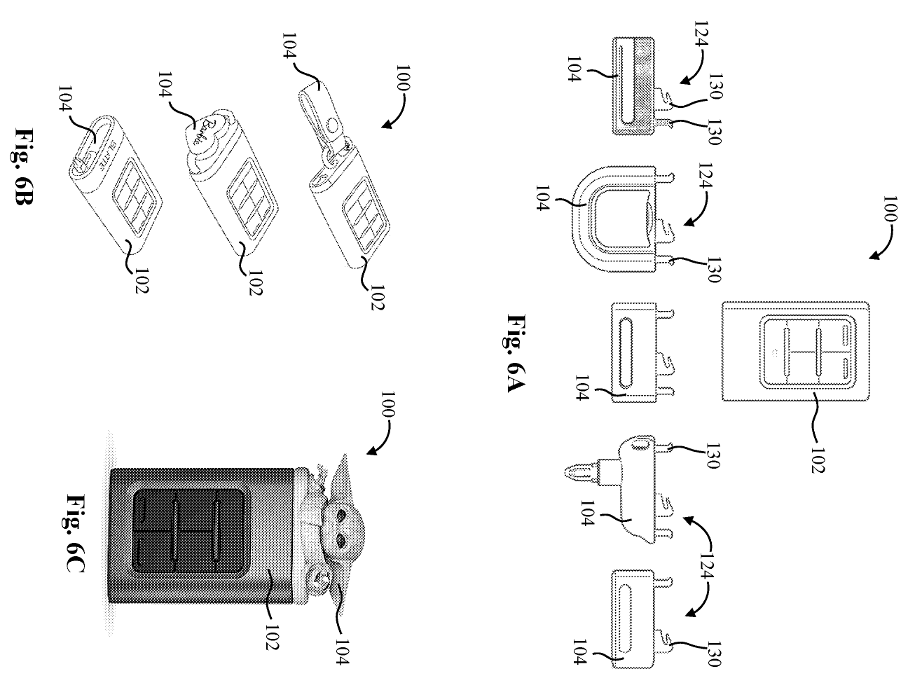

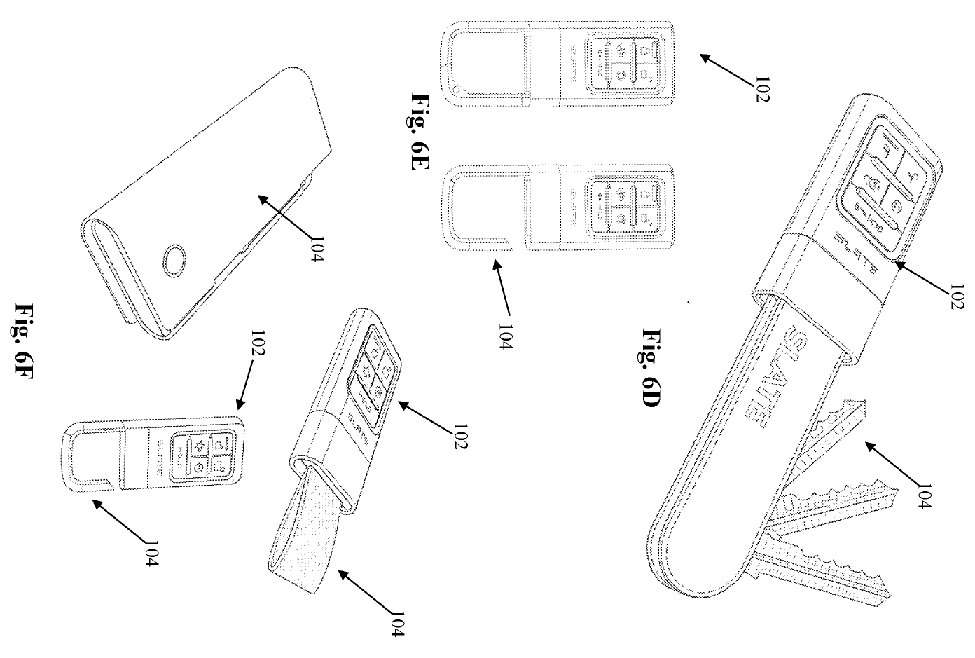

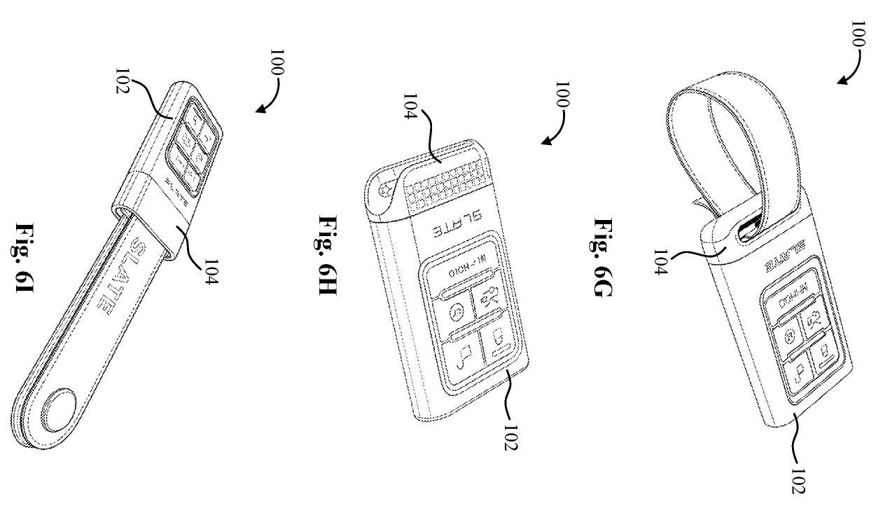

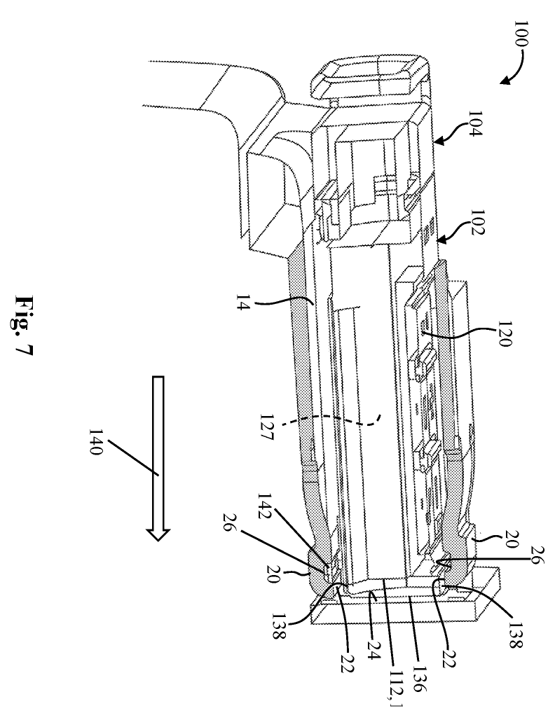

FIGS. 6A-6I illustrate various end caps 104 that can be connected to the main body 102. The end caps 104 each comprise an attachment device 124 that is configured to coact with the attachment device 122 on the main body part 102 to enable attachment and separation of the end cap 104 to and from the main body 102. For example, the attachment deivce 124 comprises one or more fingers, arms, protuberances 130 that are configured to engage complementary features (walls, openings, slots, snaps, etc.) in the main body 102 to connect the end cap and main body together.

The structure or features of the end cap 104 may vary, as shown in these figures. Accordingly, a user can separate an end cap and attach a new end cap according to their preference and/or taste.

As can be appreciated throughout these FIGS. 6A-6I, an end cap 104 may take a variety of forms, including but not limited to: a carabiner, a knife, a tool, a screw driver or bit driver, a keychain or key holder, a strap, an action figure, a sports team mascot, a logo, watch, house or garage door opener, first aid kit, pepper spray, wallet or card holder, lanyard, horn or other noise maker, keyless fob for keyless entry into a home or office or other building such as a gym, picture, EPIPEN, a cover that can pivot around the main body 102 when the main body is not in use, or any combination thereof.

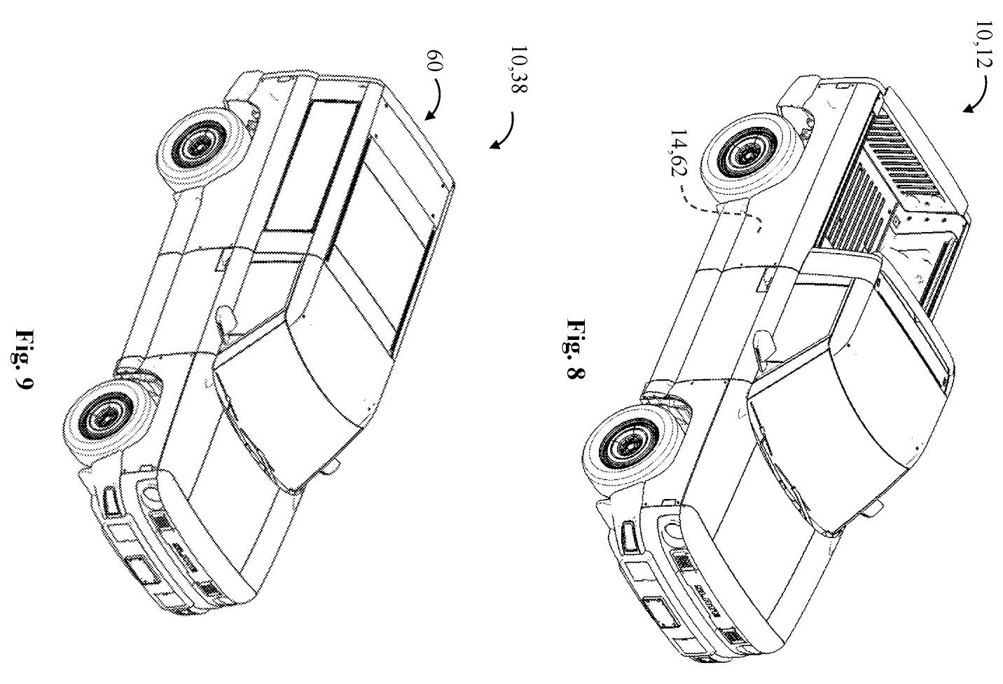

FIG. 7 illustrates a vehicle key 100 received within a vehicle key receptacle 14 of a vehicle or dashboard (FIG. 1). The receptacle 14 may be a slot, opening, port, or other feature configured to receive the vehicle key 100. In other configurations, the receptacle 14 may be located in another location of the vehicle besides the vehicle dashboard. For example, the receptacle 14 may be located in the vehicle center console, door panel, headliner, or steering wheel.

The key 100 may be inserted into the receptacle 14 along an insertion direction 140 until the first end 112 or first end wall 114 of the main body contacts, is positioned adjacent to, or is juxtaposed to an end wall 24 of the receptacle 14.

When the vehicle key 100 is fully seated within the receptacle 14, at least a portion of the end cap 104 remains exposed or positioned outside of the receptacle 14.

In some configurations, when the vehicle key 100 is fully seated within the receptacle 14, no part of the main body 102, or at least a portion of the main body 102, is exposed or positioned outside of the receptacle 14.

Before or once inserted into the receptacle 14, one or more electrical components 127 of the vehicle key 100 may communicate with corresponding vehicle systems, thereby enabling operation of one or more vehicle functions, such as starting the vehicle or controlling vehicle components.

After the vehicle key 100 is inserted into the receptacle 14, the one or more electrical components 127 of the vehicle key 100 can communicate with one or more features of the vehicle enabling a user to operate certain features of vehicle such as starting the vehicle, operating one or more components or accessories of the vehicle, etc.

The vehicle key receptacle 14 includes one or more retaining arms 20. In some configurations, the receptacle 14 includes two opposing retaining arms 20 (e.g., a top arm and a bottom arm). In some configurations, the receptacle 14 includes two opposing retaining arms 20 (e.g., a side arm and an opposing side arm).

The retaining arms 20 are configured to engage the vehicle key 100 to retain the key within the receptacle 14. More specifically, the opposing retaining arms 20 engage an engagement surface 138 of the main body 102. The engagement surface 138 may be positioned near a top portion of the main body 102, above an aperture 134 through which buttons 120 of a keypad are accessible. The engagement surfaces 138 are also identified in FIGS. 3A, 3B.

The distal ends of the retaining arms 20 may include a protuberance 22 configured to contact and/or interfere with the engagement surfaces 138 at distal end regions 136 of the vehicle key 100. This interference may apply a retention force to opposing sides of the key 100 to provide a secure fit within the receptacle 14 and reduce unintended movement or disconnection. The engagement surface(s) may comprise a protrusion, recess, notch, ramp, undercut, or other geometry configured to interact with a corresponding feature of the retaining arms.

The main body 102 of the key 100 may comprise an engagement feature 142 (see also FIG. 3B) that is configured to be received into a detent 26 in either the top retaining arm 20 or a detent in the bottom retaining arm when the key 100 is inserted into the receptacle. The engagement feature 142 may be a horizontal rib on the bottom side of the main body. The engagement between the horizontal rib and detent may provide additional friction and/or interference fit to ensure the key 100 remains in the receptacle.

The engagement feature 142 may be located only on the bottom side of the main body, and is configured to be received into the detent in either the top retaining arm or the detent in the bottom retaining arm depending on an orientation in which the electronic vehicle key is inserted into the vehicle key receptacle. Accordingly, the electronic vehicle key is configured to be received into the vehicle key receptacle in a first orientation with the buttons facing up and in a second orientation with the buttons facing down.

The key 100 may be inserted into the receptacle 14 with sufficient force to elastically deflect the retaining arms 20, allowing the key body to pass into the receptacle. Preferably, the insertion force does not exceed approximately 30 N ±10% to reduce user fatigue and provide consistent ergonomic performance.

The vehicle key 100 may be inserted into the receptacle 14 with the buttons 120 facing upward or downward. This enables a user to insert a vehicle key 100 into the receptacle 14 in any orientation, which may be advantageous if the user or vehicle operator is in a hurry or rush.

The vehicle key 100 may be removed from the receptacle 14 by pulling on the portion of the end cap 104 or main body 102 that extends outwardly from the receptacle. The extraction force may be between approximately 10 N and 30 N.

A retaining force of first and second attachment features securing the end cap 104 to the main body 102 is greater than the retaining force exerted by the arms 20 on the main body 102 when the key 100 is inserted in the receptacle 14. This relationship helps ensure that the entire key 100 (including both the end cap and main body) is removed as a unit, rather than the end cap 104 separating from the main body 102 while the main body 102 remains retained within the receptacle 14.

The retaining force of the first and second attachment features may be approximately 1×, 2×, 3×, or 4× greater than the retaining force of the arms 20 acting on the main body 102 when the key 100 is inserted into the receptacle 14. In other configurations, the arms 20 may include two or more side arms configured to engage opposing lateral surfaces of the main body 102.

FIGS. 8 and 9 illustrate a vehicle 10 that is reconfigurable between a pickup truck configuration 12 and a sport utility vehicle (SUV) configuration 38. The vehicle includes a vehicle frame 14 configured to support both the pickup truck configuration 12 and the SUV configuration 38 and to allow reconfiguration therebetween without permanently modifying the vehicle frame 14. The vehicle may be reversibly reconfigurable between the two configurations or vehicle states 12, 38.

A rear enclosure assembly 60 may be attached to one or more preexisting fasteners 62 on the vehicle frame 14 to reconfigure the vehicle from the pickup truck configuration 12 to the SUV configuration 38. The use of the preexisting fasteners 62 enables installation without drilling, welding, cutting, or otherwise permanently altering the vehicle frame 14.

As used herein, “preexisting” refers to fastening features incorporated into or on the vehicle frame by the original vehicle manufacturer during original manufacture and prior to the vehicle being placed into service. For example, the plurality of preexisting frame fastening devices comprise threaded fasteners, weld nuts, threaded bores, or combinations thereof installed prior to reconfiguration of the vehicle. The rear enclosure assembly is attachable to the vehicle frame without welding, bonding, cutting, drilling, or grinding the vehicle frame. The rear enclosure assembly is removable from the vehicle frame to return the vehicle to the pickup truck configuration using the plurality of preexisting frame fastening devices.

The rear enclosure assembly 60 may include a roll bar assembly, a hoop structure defined by opposing pillars and at least one cross bar extending therebetween, and a rear seat assembly. One or more of these components may be attached to the vehicle frame 14 via the preexisting fasteners 62 such that occupant loads from the rear seat assembly are transferred to the vehicle frame 14. In some configurations, the roll bar assembly and associated structure are configured to provide defined load paths and structural performance sufficient to comply with applicable federal crash and rollover standards.

Further aspects of the vehicle 10, the one or more configurations or states 12, 38, the rear enclosure assembly 60, and elements thereof are disclosed in U.S. Patent Application No. 19/642,294 filed on Apr. 08, 2026, the entirety of which is incorporated herein by reference.

The vehicle configured to be operated with the vehicle key and receptacle according to these teachings may include one or more land-based vehicles, such as passenger cars, trucks, sport utility vehicles (SUVs), vans, buses, motorcycles, all-terrain vehicles (ATVs), utility task vehicles (UTVs), side-by-side vehicles, recreational vehicles (RVs), construction vehicles, agricultural vehicles, and trailers. The vehicle may additionally include watercraft (e.g., boats, personal watercraft, ships, and other marine vessels) and aircraft (e.g., airplanes, helicopters, drones, and other aerial vehicles). The disclosed concepts may further be applied to other transport or recreational platforms that utilize keyed operation, regardless of propulsion type or operating environment.

In other configurations, the electronic key, or one or more features of the electronic key described herein, may be implemented in non-vehicular applications. For example, the electronic key may be configured to control access to entry systems such as residential doors, commercial or office doors, garage doors, gates, or secured enclosures.

Additionally, the electronic key may be used in connection with other types of vehicles and mobile platforms beyond passenger automobiles. For example, the electronic key may be configured for use with watercraft (e.g., boats, personal watercraft), recreational vehicles (e.g., campers, motorhomes, all-terrain vehicles), motorcycles, bicycles, scooters, aircraft, or other transportation devices. In such implementations, the electronic key may enable one or more functions including, but not limited to, locking and unlocking, ignition control, system activation, user authentication, and/or access to storage compartments.

It should be appreciated that the structural and functional features described herein may be selectively incorporated, combined, or modified depending on the particular application, and that the electronic key is not limited to vehicular environments unless explicitly recited in the claims.

In some configurations, the vehicle may be reconfigurable or reversibly configurable between different vehicle configurations. In some embodiments, the vehicle may be reconfigured from a first vehicle configuration to a second vehicle configuration. The vehicle can be reconfigured back to the first vehicle configuration. In other words, the vehicle has a reversible configurable structure. The vehicle can be reconfigured or reversibility configured between a pickup truck configuration and a sport utility vehicle (SUV) configuration.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory. Components of the present description may be provided as components of original equipment vehicle, and/or provided as aftermarket components for installation on an original equipment vehicle (optionally using at least some of the hardware provided in the original equipment vehicle).

In the context of the present description, one of the vehicle configurations (e.g., first vehicle configuration or second vehicle configuration) may be a pickup truck or pickup truck configuration. In the context of the present description, the other vehicle configuration (e.g., first vehicle configuration or second vehicle configuration) may be a sport utility vehicle (SUV) or SUV configuration.

In the context of the present description, a “pickup truck” includes a vehicle that may be a light, medium-duty or heavy-duty truck. The pickup truck configuration may include a vehicle having an enclosed cab or cockpit (for at least a driver and at least one occupant) and an open cargo area, namely a bed, located in the rear portion of the vehicle and being operable for storing and/or transporting cargo. The bed or cargo area may have a size that is less than 8 foot, less than 7 foot, preferably less than 6 feet, more preferably about 5 feet long. A pickup truck configuration may be a vehicle that does not include a C-pillar, e.g., does not include a C-pillar that defines part of a passenger cab. A pickup truck configuration may be a vehicle that does not include a D-pillar. A pickup truck configuration may be a vehicle that has a removable bulk head panel and rear window or glass assembly that can be completely removed or separated from the vehicle. A pickup truck configuration does not include features of a minivan.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. An electronic vehicle key for a vehicle that is reconfigurable between a pickup truck configuration and a sport utility vehicle (SUV) configuration, the vehicle comprising a vehicle frame configured to support both the pickup truck configuration and the SUV configuration and to allow reconfiguration therebetween without permanently modifying the vehicle frame, comprising, comprising: a main body comprising an enclosed interior space defined between a top side and an opposing bottom side, a first end having a first end wall, and an opposing second end having a second end wall, the enclosed interior space containing one or more electrical components configured to enable the electronic vehicle key to communicate with the vehicle and/or to operate one or more vehicle features; one or more buttons at the top side of the main body; a first attachment feature located at the second end of the main body; and an end cap comprising a second attachment feature configured to removably engage the first attachment feature; wherein, upon removal of the end cap from the main body, access to the enclosed interior space remains blocked by the second end wall.

2. The electronic vehicle key according to claim 1, wherein the first attachment feature comprises a sleeve, receptacle, or pocket.

3. The electronic vehicle key according to claim 2, wherein the sleeve, receptacle, or pocket comprises a surrounding wall extending distally beyond the second end wall such that the second end wall is recessed relative to a distal-most end of the main body.

4. The electronic vehicle key according to claim 3, wherein the surrounding wall comprises a pair of long wall portions or segments and a pair of short wall portions or segments, and the short wall portions or segments are arranged generally perpendicular to the long wall portions or segments, and the first attachment feature further comprises an engagement opening defined in one of the long wall portions of the surrounding wall.

5. The electronic vehicle key according to claim 4, wherein the engagement opening is positioned on the bottom side of the main body.

6. The electronic vehicle key according to claim 5, wherein the second attachment feature comprises a male part sized to be received within the sleeve, receptacle, or pocket.

7. The electronic vehicle key according to claim 6, wherein the male part comprises one or more fingers cantilevering from the end cap.

8. The electronic vehicle key according to claim 7, wherein one of the one or more fingers comprises a protuberance configured to engage the engagement opening.

9. The electronic vehicle key according to claim 8, wherein the one or more fingers are biasable and/or elastically deformable such that, during insertion of the second attachment feature into the first attachment feature, the one or more fingers deflect and thereafter return toward an unbiased state.

10. The electronic vehicle key according to claim 9, wherein the engagement between the second attachment feature and the first attachment feature is provided by an interference fit, a friction fit, a snap-fit engagement, or a combination thereof.

11. The electronic vehicle key according to claim 10, wherein the end cap is removable by applying a force to the protuberance through the engagement opening to bias the finger inwardly and out of engagement with the engagement opening.

12. The electronic vehicle key according to claim 1, wherein the main body is configured to be received within a vehicle key receptacle of the vehicle, and attachment of the end cap does not increase one or more dimensions of the main body beyond a size that would interfere with insertion of the electronic vehicle key into the vehicle key receptacle.

13. The electronic vehicle key according to claim 12, wherein the main body comprises an engagement surface on the top side of the main body and on the bottom side of the main body, the vehicle key receptacle comprises a top retaining arm and a bottom retaining arm, wherein the main body is configured to be received between the top retaining arm and the bottom retaining arm so that the top retaining arm engages the engagement surface eon the top side and the bottom retaining arm engages the engagement surface on the bottom side of the main body.

14. The electronic vehicle key according to claim 13, wherein the engagement surface is located distal to the opening in the main body through which the one or more buttons are accessible.

15. The electronic vehicle key according to claim 14, wherein each of the top retaining arm and the bottom retaining arms comprises a protrusion configured to engage the corresponding engagement surface to create an interference or friction fit.

16. The electronic vehicle key according to claim 15, wherein after the electronic vehicle key is inserted into the receptacle, at least a portion of the end cap remains outside of the receptacle.

17. The electronic vehicle key according to claim 16, wherein a retaining force between the first and second attachment features is greater than a retaining force exerted by the retaining arms on the main body.

18. The electronic vehicle key according to claim 15, wherein the vehicle key receptacle comprises a top retaining arm and a bottom retaining arm, the main body comprises an engagement feature that is configured to be received into a detent in either the top retaining arm arm or the detent in the bottom retaining arm.

19. The electronic vehicle key according to claim 18, wherein the engagement feature is a horizontal rib on the bottom side of the main body.

20. The electronic vehicle key according to claim 19, wherein the engagement feature is located only on the bottom side of the main body, and is configured to be received into the detent in either the top retaining arm or the detent in the bottom retaining arm depending on an orientation
in which the electronic vehicle key is inserted into the vehicle key receptacle, wherein the electronic vehicle key is configured to be received into the vehicle key receptacle in a first orientation with the buttons facing up and in a second orientation with the buttons facing down.
